(19) United States
(12) Patent Application Publication
(10) Pub. No.: US 2016/0188281 A1
(43) Pub. Date: Jun. 30, 2016

(54) SYSTEM AND METHOD FOR EXTERNAL DISPLAY

(71) Applicant: HUIZHOU TCL MOBILE COMMUNICATION CO., LTD., Guangdong (CN)

(72) Inventors: Minli LUO, Huizhou, Guangdong (CN); Wei YING, Huizhou, Guangdong (CN)

(73) Assignee: Huizhou TCL Mobile Communication Co., Ltd., Huizhou, Guangdong (CN)

(21) Appl. No.: 14/893,198

(22) PCT Filed: Jan. 8, 2015
(86) PCT No.: PCT/CN2015/070365

§ 371 Date: Nov. 23, 2015

(30) Foreign Application Priority Data
Aug. 7, 2014 (CN) 201410387582.3

(51) Int. Cl. G06F 3/14; G06F 3/0354; G06F 3/02

(52) U.S. Cl. CPC G06F 3/1462; G06F 3/02; G06F 3/03543

(57) ABSTRACT

A system and method for external display is disclosed. The system includes: a mobile device comprised of a first communication module, a storage module configured to store at least a first interface and a second interface, and a processing module connected to the first communication module and the storage module; a display device including a second communication module and a display module. The processing module generates external display information and broadcasts the external display information through the first communication module. The second communication module acquires the external display information and transmits information of the display device to the processing module based on external display information. The processing module determines whether the display device is in accordance with the second interface based on information of the display device, if so, the mobile device transmits the second interface to the display device to make the display device display the second interface. By the above means, the present disclosure allows for external display with the mobile device so as to enhance the user experience.

### FIELD OF THE DISCLOSURE

The present disclosure relates to the field of external display technologies, and more particularly, to a system and method for external display.

### BACKGROUND OF THE DISCLOSURE

With the advancement and development of communication technologies, smart phones are becoming more and more popular. Accordingly, the dominant frequency of the processor of a smart phone is becoming higher and higher, ranging from 800 MHz to 2.3 GHz, or even higher. And cores in the processor are increasing from single-core to multi-core. Thus, the data processing capabilities of existing smartphones are becoming stronger and stronger. The performance can even be comparable to an ordinary notebook computer. However, when processing documents, receiving or sending emails, or watching a video on a smartphone, limited by its size and screen, the user experience is not as good as that on an ordinary notebook computer.

### SUMMARY OF THE DISCLOSURE

A system and method for external display is provided by embodiments of the present disclosure, making possible external display with a smartphone and thus enhancing the user experience.

According to a first aspect of the present disclosure, a system for external display is provided, the system comprising: a smart phone comprised of a first communication module, a storage module configured to store at least a first interface displayed by the smartphone and a second interface, and a processing module connected to the first communication module and the storage module; a display device comprised of a second communication module configured to establish a connection with the first communication module, a display module connected to the second communication module, a keyboard input module connected to the second communication module and configured to enable keyboard input operations on the second interface, and a mouse input module connected to the second communication module and configured to enable cursor moving operations on the second interface; wherein, the first and second communication modules are both WiFi (wireless fidelity) modules and establish a connection via the wireless WiFi; the processing module may generate external display information and broadcast the external display information through the first communication module; the second communication module may acquire the external display information and transmit the information of the display device to the processing module based on the external display information; the processing module may determine whether the display device is in accordance with the second interface based on the information of the display device, if so, the smartphone may transmit the second interface to the display device to make the display device display the second interface.

The information of the display device may include WiFi display (WFD) device information of the second communication module, and an identifier of the display device may be set on a reserved bit of the WFD device information.

Determining by the processing module whether the display device is in accordance with the second interface based on the information of the display device may include: if the processing module determines that the reserved bit in the WFD device information is set to be 1, then the display device is in accordance with the second interface.

According to a second aspect of the present disclosure, a system for external display is provided, the system comprising: a mobile device comprised of a first communication module, a storage module configured to store at least a first interface displayed by the mobile device and a second interface, and a processing module connected to the first communication module and the storage module; a display device comprised of a second communication module configured to establish a connection with the first communication module, and a display module connected to the second communication module; wherein, the processing module may generate external display information and broadcast the external display information through the first communication module; the second communication module may acquire the external display information and transmit the information of the display device to the processing module based on the external display information; the processing module may determine whether the display device is in accordance with the second interface based on the information of the display device, if so, the mobile device may transmit the second interface to the display device to make the display device display the second interface.

The first communication module and the second communication module are both WiFi modules and establish a connection via the wireless WiFi.

The information of the display device may include WFD device information of the second communication module, and an identifier of the display device may be set on a reserved bit of the WFD device information.

Determining by the processing module whether the display device is in accordance with the second interface based on the information of the display device may include: if the processing module determines that the reserved bit in the WFD device information is 1, then the display device is in accordance with the second interface.

The display device may further include: a keyboard input module connected to the second communication module and configured to enable keyboard input operations on the second interface; a mouse input module connected to the second communication module and configured to enable cursor moving operations on the second interface.

The mobile device may be a smartphone, a tablet computer or an ipad, and the display device may be a smartbook or a television.

According to a third aspect, a method based on the external display system is provided for external display, where the external display system includes a mobile device and a display device, the mobile device including at least a first interface and a second interface, the method comprising: generating by the mobile device external display information and broadcasting the external display information; acquiring by the mobile device the information of the display device from the display device, and determining whether the display device is in accordance with the second interface based on the information of the display device; if so, transmitting by the mobile device the second interface to the display device to make the display device display the second interface.

The mobile device and the display device may establish a connection via the wireless WiFi.

The information of the display device may include WFD device information, and an identifier of the display device may be set on a reserved bit of the WFD device information.

Determining whether the display device is in accordance with the second interface based on the information of the display device may include: if determining that the reserved bit in the WFD device information is 1, then the mobile device determines that the display device is in accordance with the second interface.

By the above solution, the present disclosure may provide the following beneficial effects: through obtaining the information of the display device, the processing module determines whether the display device is in accordance with the second interface based on the information of the display device, if so, the mobile device transmits the second interface to the display device to make the display device display the second interface, thus enabling the second interface of the mobile device to be displayed on the display device and therefore enhancing the user experience.

### BRIEF DESCRIPTION OF THE DRAWINGS

FIG. 1 is a schematic diagram of a system for external display according to a first embodiment of the present disclosure.

FIG. 2 illustrates the format of WFD information elements as illustrated in FIG. 1.

FIG. 3 illustrates the format of WFD sub-elements as illustrated in FIG. 1.

FIG. 4 illustrates the format of sub-elements body field as illustrated in FIG. 1.

FIG. 5 illustrates the format of the WFD device information as illustrated in FIG. 1.

FIG. 6 is a flow chart illustrating a method for external display according to the first embodiment of the present disclosure.

### DETAILED DESCRIPTION OF THE DISCLOSURE

Below a definite and complete description will be made on the technical solution according to embodiments of the present disclosure with reference to the accompanying drawings of embodiments of the present disclosure. Apparently, the described embodiments are merely some but not all of the embodiments of the present disclosure. Based on the embodiments of the present disclosure, all other embodiments obtained by those of ordinary skill in the art without making inventive effort shall fall within the protection scope of the present disclosure.

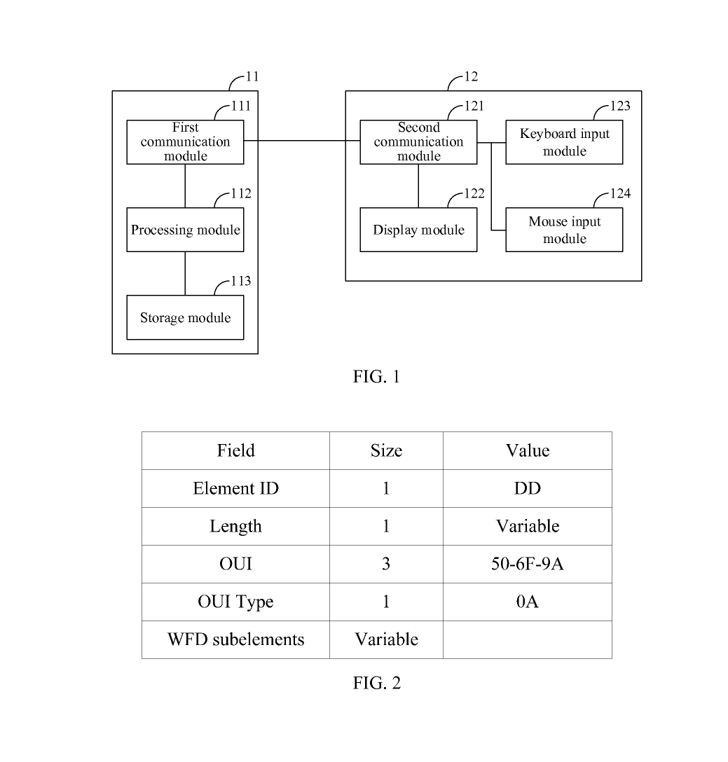

Referring now to FIG. 1, a schematic diagram of a system for external display according to a first embodiment of the present disclosure is shown. As is shown in FIG. 1, the external display system 10 illustrated in the present embodiment comprises a mobile device 11 and a display device 12.

The mobile device 11 comprises a first communication module 111, a processing module 112 and a storage module 113. The processing module 112 is connected to the first communication module 111 and the storage module 113. The mobile device 11 is connected to the external display device 12 through the first communication module 111. The storage module 113 is configured to store at least a first interface displayed by the mobile device 11 as the default interface and a second interface. In other embodiments, those of ordinary skill in the art can certainly set multiple interfaces each paired with a display device, so as to make each of the multiple display devices display a corresponding interface.

The display device 12 comprises a second communication module 121, a display module 122, a keyboard input module 123 and a mouse input module 124. The second communication module 121 is connected to the display module 122, the keyboard input module 123 and the mouse input module 124, respectively. The second communication module 121 is configured to establish a connection with the first communication module 111. The keyboard input module 123 is configured to enable keyboard input operations on the second interface displayed on the display module 122. The mouse input module 124 is configured to enable cursor moving operations on the second interface displayed on the display module 122. A movable cursor would appear on the second interface when the second interface is displayed on the display module 122. The movable cursor may facilitate the user to input through the mouse input module 124. In addition, the display module 122 can also be a touch screen, and the user may touch the touch screen to realize manipulation of the second interface.

Preferably, the first communication module 111 and the second communication module 112 are both WiFi modules and establish a connection via the wireless WiFi. In other embodiments, those of ordinary skill in the art can certainly utilize other means to establish a connection between the first communication module 111 and the second communication module 121. For example, the first communication module 111 and the second communication module 121 may establish a connection via the mobile high-definition audio/video standard interface, physically, via the mobile high-definition link (MHL) cable.

The processing module 112 is configured to generate external display information and broadcast the external display information through the first communication module 111. The second communication module 121 may acquire the external display information and transmit the information of the display device 12 to the first communication module 111 based on the external display information. The processing module 112 may acquire the information of the display device 12 via the first communication module 111. The processing module 112 may determine whether the display device 12 is in accordance with the second interface based on the information of the display device 12. If so, the mobile device 11 may transmit the second interface to the display device 12 through the first communication module 111 to make the display device 12 display the second interface, thus realizing external display with the mobile device 11.

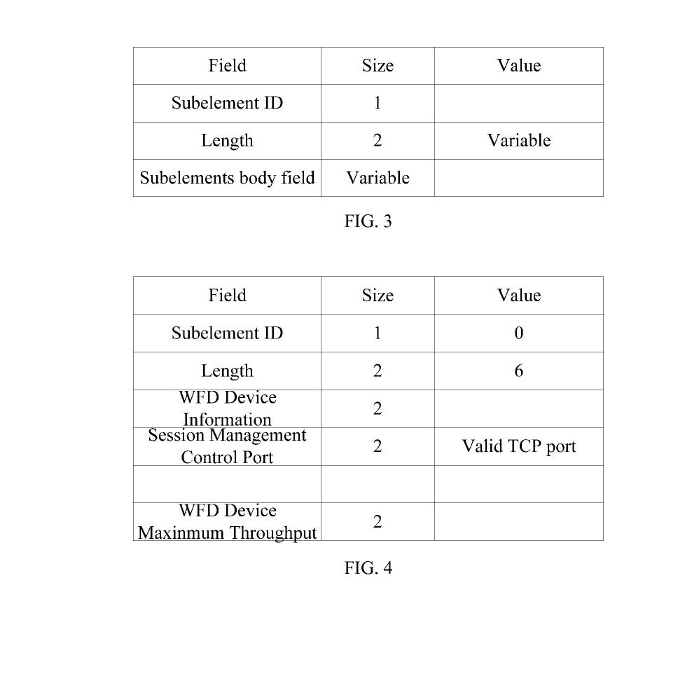

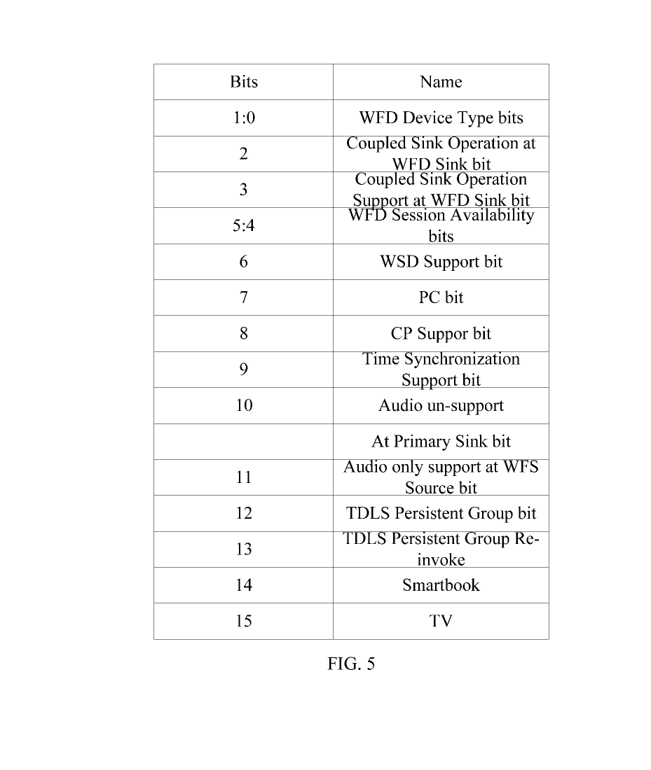

Both the first communication module 111 and the second communication module 121 adopt the WiFi display (WFD) protocol. The WiFi display protocol may include WFD information elements. The format of the WFD information elements is illustrated in FIG. 2. The WFD information elements may include WFD sub-elements of which the format is illustrated in FIG. 3. The WFD sub-elements may further include sub-elements body fields of which the format is illustrated in FIG. 4. And the sub-elements body field may include the WFD device information, the format of the WFD device information is illustrated in FIG. 5. Referring now to FIG. 5, the WFD device information is a 2 bytes data with bits 0-13 being the existing bits having clear definition and bits 14 and 15 being the reserved bits.

The information of the display device 12 may include the WFD device information, and an identifier of the display device 12 is set on a reserved bit of the WFD device information. For example, the identifier of the display device 12 may be set on bit 14 of the WFD device information. Determining by the processing module 112 whether the display device 12 is in accordance with the second interface based on the information of the display device 12 may include: if the processing module 112 determines that the reserved bit of the WFD device information is set to be 1 (i.e., the bit 14 is 1), then the display device 12 is in accordance with the second interface; if the processing module 112 determines that the reserved bit of the WFD device information is set to be 0 (i.e., the bit 14 is 0), then the display device 12 is not in accordance with the second interface.

Below the present disclosure will be described in detail taking the display device 12 as a smartbook for example. The smartbook looks the same in appearance with an ordinary notebook computer, but the smartbook doesn't have a central processor, a hard disk, a memory chip, and the like. The smartbook can be used in combination with the mobile device 11, resulting in no difference with an ordinary notebook book computer, which thus can reduce the cost.

The processing module 112 of the mobile device 11 may generate external display information and broadcast the external display information through the first communication module 111. The second communication module 121 of the display device 12 may acquire the external display information from the first communication module 111 and transmit the WFD device information to the first communication module 111. The display device 12 may define bit 14 or bit 15 of the WFD device information as the smartbook. For example, the bit 14 may be defined as the smartbook, while bit 15 is reserved.

The processing module 112 of the mobile device 11 may acquire the WFD device information from the first communication module 111, and determines whether the bit 14 in the WFD device information is 1. If so, then the processing module 112 may acquire the second interface corresponding to the display device 12 from the storage module 113, and transmit the second interface to the display device 12 through the first communication module 111. The display device 12 may acquire the second interface via the second communication module 121 and display the second interface on the display module 122. If not, the first communication module 111 of the mobile device 11 may disconnect with the second communication module 121 of the display device 12.

When the second interface is displayed on the display module 122 of the display device 12, the user may manipulate the second interface via the keyboard input module 123 and the mouse input module 124.

The mobile device 11 may be a smartphone, a tablet computer or an ipad, and the display device may be a television, a display device or a smartbook.

Additionally, when the display device 12 is a television, the display device 12 may define bit 15 of the WFD device information as the television, and set the bit 14 to be 0. If the processing module 112 determines that the reserved bit 14 of the WFD device information is 0, the processing module 112 may further determine whether the reserved bit 15 in the WFD device information is 1, if so, the processing module 112 may acquire a third interface associated with the television from the storage module 113, and transmit the third interface to the display device 12 to make the display device 12 display the third interface.

In the present embodiment, the first communication module 111 obtains the information of the display device 12, and the processing module 112 determines whether the display device 12 is in accordance with the second interface based on the information of the display device 12, if so, the mobile device 11 may transmit the second interface to the display device 12 to make the display device 12 display the second interface, thus enabling the second interface of the mobile device 11 to be displayed on the display device 12, thereby enhancing the user experience.

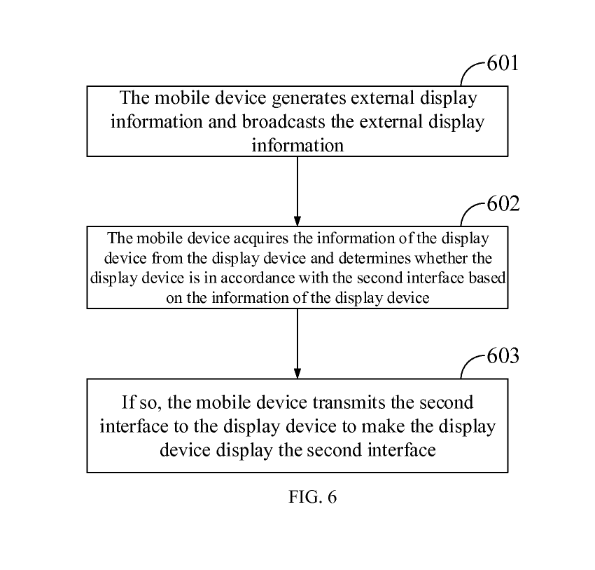

The present disclosure further provides a method for external display, which will be described on the basis of the external display system 10 as illustrated in the first embodiment. As is shown in FIG. 6, the method for external display to be illustrated by the present embodiment comprises:

S601: generating, by the mobile device 11, external display information, and broadcasting the external display information;

S602: acquiring, by the mobile device 11, the information of the display device 12 from the display device 12, and determining whether the display device 12 is in accordance with the second interface based on the information of the display device 12;

S603: if so, transmitting, by the mobile device 11 the second interface to the display device 12 to make the display device 12 display the second interface.

In the step S601, the display device 12 acquires the external display information from the mobile device 11, and transmits the information of the display device 12 to the mobile device 11 based on the external display information.

In the step S602, the mobile device 11 may establish a connection with the display device 12 via the wireless WiFi. The information of the display device 12 may include WFD device information, and an identifier of the display device 12 is set on a reserved bit of the WFD device information. The mobile device 11 may determine whether the reserved bit of the WFD device information is 1.

In the step S603, if the mobile device 11 determines that the reserved bit of the WFD device information is 1, the mobile device 11 determines that the display device 12 is in accordance with the second interface, and transmits the second interface to the display device 12.

As a conclusion, in the present disclosure, the mobile device 11 obtains the information of the display device 12, and determines whether the display device 12 is in accordance with the second interface based on the information of the display device 12, if so, the mobile device 11 transmits the second interface to the display device 12 to make the display device 12 display the second interface, thus enabling the second interface of the mobile device 11 to be displayed on the display device 12 and therefore enhancing the user experience.

What is described above is merely embodiments of the present disclosure, thus shouldn't be construed to be limiting the patent scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A system for external display, the system comprising:
a smartphone, comprising:
a first communication module;
a storage module configured to store at least a first interface displayed by the smartphone and a second interface;
a processing module connected to the first communication module and the storage module;
a display device, comprising:
a second communication module configured to establish a connection with the first communication module;
a display module connected to the second communication module;
a keyboard input module connected to the second communication module and configured to enable keyboard input operations on the second interface;
a mouse input module connected to the second communication module and configured to enable mouse input operations on the second interface;
wherein, the first and second communication modules are both WiFi (wireless fidelity) modules, and establish a connection via wireless WiFi; the processing module generates external display information and broadcasts the external display information through the first communication module; the second communication module acquires the external display information, and transmits the information of the display device to the processing module based on the external display information; the processing module determines whether the display device is in accordance with the second interface based on the information of the display device, if so, the smartphone transmits the second interface to the display device to make the display device display the second interface.

2. The system according to claim 1, wherein the information of the display device comprises WFD (WiFi display) device information of the second communication module, and an identifier of the display device is set on a reserved bit of the WFD device information.

3. The system according to claim 2, wherein determining by the processing module whether the display device is in accordance with the second interface based on the information of the display device comprises:
when the processing module determines that the reserved bit of the WFD device information is 1, the display device is determined to be in accordance with the second interface.

4. A system for external display, comprising:
a mobile device, comprising:
a first communication module;
a storage module configured to store at least a first interface displayed by the mobile device and a second interface;
a processing module connected to the first communication module and the storage module;
a display device, comprising:
a second communication module configured to establish a connection with the first communication module;
a display module connected to the second communication module;
wherein, the processing module generates external display information and broadcasts the external display information through the first communication module; the second communication module acquires the external display information, and transmits the information of the display device to the processing module based on the external display information; the processing module determines whether the display device is in accordance with the second interface based on the information of the display device, if so, the mobile device transmits the second interface to the display device to make the display device display the second interface.

5. The system according to claim 4, wherein the first and second communication modules are both WiFi modules, and establish a connection via wireless WiFi.

6. The system according to claim 5, wherein the information of the display device comprises WFD device information of the second communication module, and an identifier of the display device is set on a reserved bit of the WFD device information.

7. The system according to claim 6, wherein determining by the processing module whether the display device is in accordance with the second interface based on the information of the display device comprises:
when the processing module determines that the reserved bit of the WFD device information is 1, the display device is determined to be in accordance with the second interface.

8. The system according to claim 4, wherein the display device further comprises:
a keyboard input module connected to the second communication module and configured to enable keyboard input operations on the second interface;
a mouse input module connected to the second communication module and configured to enable mouse input operations on the second interface.

9. The system according to claim 4, wherein the mobile device is a smartphone, a tablet computer or an ipad, and the display device is a smartbook or a television.

10. A method for external display, wherein the method is based on a system for external display, the system comprising a mobile device and a display device, and the mobile device comprising at least a first interface and a second interface, the method comprising:
generating, by the mobile device, external display information, and broadcasting the external display information;
acquiring, by the mobile device, information of the display device from the display device, and determines whether the display device is in accordance with the second interface based on the information of the display device;
if so, transmitting, by the mobile device, the second interface to the display device to make the display device display the second interface.

11. The method according to claim 10, wherein the mobile device establishes a connection with the display device via wireless WiFi.

12. The method according to claim 11, wherein the information of the display device comprises WFD device information, and an identifier of the display device is set on a reserved bit of the WFD device information.

13. The method according to claim 12, wherein determining whether the display device is in accordance with the second interface based on the information of the display device comprises:
when the mobile device determines that the reserved bit of the WFD device information is 1, the display device is determined to be in accordance with the second interface.
